(19) United States
(12) Patent Application Publication
(10) Pub. No.: US 2026/0172832 A1
(43) Pub. Date: Jun. 18, 2026

(54) TECHNIQUES FOR DETECTION OF FRAUDULENT ACTIVITY IN A DISTRIBUTED SERVICES SYSTEM

(71) Applicant: Stripe, Inc., South San Francisco, CA (US)

(72) Inventors: Anthony Pianta, Washington, DC (US); Chauncy Cullitan, Nine Mile Falls, WA (US); Shaobo Sun, Mountain View, CA (US); Manav Jai Khandelwal, New York, NY (US); Angel Samsuddin Maredia, New Rochelle, NY (US); Juan Carlos Arteaga Amate, Seattle, WA (US)

(21) Appl. No.: 18/982,826

(22) Filed: Dec. 16, 2024

(51) Int. Cl. H04W 12/121

(52) U.S. Cl. CPC H04W 12/121

(57) ABSTRACT

A server computer system may determine a set of data related to a set of jobs processed by a computing platform on behalf of subscribers to the computing platform as part of an attribute analysis to facilitate the detection of fraudulent activity on the computing platform. The set of data may include, for each job, a set of attribute-value pairs corresponding to a set of attributes utilized to parameterize each job in the set of jobs. An ML model may generate a ranked list of the set of attribute-value pairs based on predictive utility of each attribute-value pair for identifying jobs involving fraudulent activity. The server computer system may determine a set of statistics for a threshold number of top attribute-value pairs in the ranked list in. Further, the server computer system may present the set of statistics for the threshold number of top attribute-value pairs via a graphical user interface.

### FIELD OF DISCLOSURE

This disclosure is related generally to fraud detection in a distributed services processing environment, and more particularly to attribute analysis to facilitate the detection of the fraudulent activity.

### BACKGROUND

In computing, attributes may refer to a specification that defines a property of an object, element, process, job, interaction, activity, and the like. An attribute of an object usually includes a name and a value, which may be referred to as an attribute-value pair or an attribute value. For example, an attribute may include age of an account and the value for the attribute may be 342 days. Oftentimes, a set of attributes may be created and utilized to characterize or parameterize objects, elements, processes, jobs, activities, interactions, and the like. Data including values for various attributes parameterizing a job may be generated, collected, and/or utilized, such as during processing the job. Further, the values for the set of attributes may be utilized to draw conclusions regarding the objects, elements, and/or processes, such as whether or not the objects, elements, and/or processes involve fraud.

Fraud, or fraudulent activity, generally refers to a deception utilized to deprive a victim of a right or interest. For example, a malicious actor may commit fraud by attempting to have a computing platform process an illegitimate job that transfers an item of value, such as sensitive data, a media asset, etc., from a first account of a victim to a second account of the malicious actor. To prevent fraudulent jobs, computing platforms may perform fraud detection on a job before, during, and/or after processing the job. Such fraud detection can include attempting to determine, based on attributes associated with a job, whether there is a likelihood that the job is fraudulent. Thus, the fraud detection generally seeks to determine when one or more values for attributes associated with a job indicate the job is fraudulent and prevent or stop performance of the job based on such a determination.

However, fraudulent activity can occur quickly and is ever changing. Further, large sets of attributes-value pairs are typically required to accurately characterize objects, elements, processes, jobs, activities, and the like. An additional complication exists in distributed services system where a volume of individual jobs, activities, processes performed among the distributed services of the distributed services system. Thus, a technical challenges exists for analyzing attributes and providing fraud assessments in a quick and actionable manner. Therefore, an improved technique for analyzing attributes to gain insights for facilitating the prevention of fraudulent activity in a quick and actionable manner is a technical challenge to be solved.

### BRIEF SUMMARY

Processes, apparatuses, machines, and articles of manufacture for attribute analysis for the detection of fraudulent activity in a distributed services system are described. It will be appreciated that the embodiments may be combined in any number of ways without departing from the scope of this disclosure.

Example methods, such as computer-implemented methods for obtaining insights from detected fraudulent activity in a distributed services system, the method comprising are described herein. An example method may include: determining, by a server computer system of the distributed services system, a set of data related to a set of jobs processed by a computing platform on behalf of subscribers to the computing platform, the set of data including, for each job, a set of attribute-value pairs corresponding to a set of attributes utilized to parameterize each job in the set of jobs; transforming, by the server computer system, the data into input data for a machine learning (ML) model executed by the server computer system; generating, with the machine learning (ML) model executed by the server computer system, a ranked list of the set of attribute-value pairs based on predictive utility of each attribute value for identifying jobs involving fraudulent activity; identifying, by the server computer system, a request to access information associated with the set of jobs for a particular subscriber to the computing platform; determining, by the server computer system and in response to the request, a set of statistics for a threshold number of top attribute-value pairs in the ranked list; presenting, by the server computer system, the threshold number of top attribute-value pairs and the set of statistics for the threshold number of top attribute-value pairs via a graphical user interface; and generating, by the server computer system, a job processing rule for the particular subscriber based on user input identifying a top attribute-value pair in the threshold number of top attribute-value pairs.

Example server computer systems are disclosed herein. An example server computer system comprises a memory and a processor coupled to the memory configured to: determine, by a server computer system of the distributed services system, a set of data related to a set of jobs processed by a computing platform on behalf of subscribers to the computing platform, the set of data including, for each job, a set of attribute-value pairs corresponding to a set of attributes utilized to parameterize each job in the set of jobs; transform, by the server computer system, the data into input data for a machine learning (ML) model executed by the server computer system; generate, with the machine learning (ML) model executed by the server computer system, a ranked list of the set of attribute-value pairs based on predictive utility of each attribute value for identifying jobs involving fraudulent activity; identify, by the server computer system, a request to access information associated with the set of jobs for a particular subscriber to the computing platform; determine, by the server computer system and in response to the request, a set of statistics for a threshold number of top attribute-value pairs in the ranked list; present, by the server computer system, the threshold number of top attribute-value pairs and the set of statistics for the threshold number of top attribute-value pairs via a graphical user interface; and generate, by the server computer system, a job processing rule for the particular subscriber based on user input identifying a top attribute-value pair in the threshold number of top attribute-value pairs.

Example non-transitory computer-readable media are disclosed herein. An example non-transitory computer-readable storage medium includes instructions that, when executed by a processor, cause the processor to perform operations comprising: determining, by a server computer system of the distributed services system, a set of data related to a set of jobs processed by a computing platform on behalf of subscribers to the computing platform, the set of data including, for each job, a set of attribute-value pairs corresponding to a set of attributes utilized to parameterize each job in the set of jobs; transforming, by the server computer system, the data into input data for a machine learning (ML) model executed by the server computer system; generating, with the machine learning (ML) model executed by the server computer system, a ranked list of the set of attribute-value pairs based on predictive utility of each attribute value for identifying jobs involving fraudulent activity; identifying, by the server computer system, a request to access information associated with the set of jobs for a particular subscriber to the computing platform; determining, by the server computer system and in response to the request, a set of statistics for a threshold number of top attribute-value pairs in the ranked list; presenting, by the server computer system, the threshold number of top attribute-value pairs and the set of statistics for the threshold number of top attribute-value pairs via a graphical user interface; and generating, by the server computer system, a job processing rule for the particular subscriber based on user input identifying a top attribute-value pair in the threshold number of top attribute-value pairs.

Analyzing attributes for the detection of fraudulent activity in a distributed services system in this manner allows for increased accessibility, practicality, adaptability, and availability of real-time, or near-real-time, attribute analysis to facilitate the detection of fraudulent activity resulting from remote job processing requests sent to a distributed services system, thereby improving the functioning of a server systems of the distributed services system for identifying indicators of fraud as well as acting on the indications of fraud to reduce or prevent fraudulent activity as compared to conventional approaches.

Other processes, machines, and articles of manufacture are also described herein, which may be combined in any number of ways, such as with the embodiments of the brief summary, without departing from the scope of this disclosure.

### BRIEF DESCRIPTION OF THE DRAWINGS

The present disclosure will be understood more fully from the detailed description given below and from the accompanying drawings of various embodiments, which, however, should not be taken to limit the embodiments described and illustrated herein, but are for explanation and understanding only.

To easily identify the discussion of any particular element or act, the most significant digit or digits in a reference number refer to the figure number in which that element is first introduced.

FIG. 1 illustrates a block diagram of an exemplary system architecture for analyzing attributes to facilitate the detection of fraudulent activity in a distributed services processing system according to some embodiments of the current disclosure.

FIG. 2 illustrates various aspects of a server system including an interaction insight engine according to some embodiments of the current disclosure.

FIG. 3 illustrates an exemplary process flow for analyzing attributes to facilitate the identification of fraudulent activity according to some embodiments of the current disclosure.

FIG. 4 illustrates exemplary process flow involving an offline phase and an online phase of analyzing attributes according to some embodiments of the current disclosure.

FIG. 5 illustrates exemplary aspects of a graphical user interface (GUI) view of ranked attribute-value pair list according to some embodiments of the current disclosure.

FIG. 6 illustrates a logic flow of an exemplary method for attribute analysis to facilitate the detection of fraudulent activity according to some embodiments of the current disclosure.

FIG. 7 is one embodiment of a computer system that may be used to support the systems and operations discussed herein.

### DETAILED DESCRIPTION

In the following description, numerous details are set forth. It will be apparent, however, to one of ordinary skill in the art having the benefit of this disclosure, that the embodiments described herein may be practiced without these specific details. In some instances, well-known structures and devices are shown in block diagram form, rather than in detail, in order to avoid obscuring the embodiments described herein.

Some portions of the detailed description that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “receiving”, “determining”, “transforming”, “generating”, “identifying”, “presenting”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The embodiments discussed herein may also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the embodiments discussed herein are not described with reference to any particular programming language. It will be appreciated that a variety of programming languages may be used to implement the teachings as described herein.

Generally, this disclosure describes techniques for analyzing attribute-value pairs of processing jobs to facilitate the detection of fraudulent activity in a distributed services system. More specifically, embodiments are directed to a server system for implementing an interaction insight engine that determines attribute-value pairs (also referred to as top attributes) of processing jobs with the highest predictive utility for indicating jobs involving fraudulent activity. In some embodiments, job processing rules may be generated based on one or more of the attribute-value pairs with the highest predictive utility. These and other embodiments are described and claimed.

Existing techniques for analyzing attributes of processing jobs to facilitate the detection of fraudulent activity are slow and require excessive resources. For example, processing jobs may be characterized by a set of over a hundred different attributes (e.g., 180 attributes). However, analyzing each of over a hundred attributes to provide fraud assessments is a non-scalable and resource intensive process that fails to provide accurate and reliable assessments in a quick and actionable manner. For example, analyzing a plurality of attributes for each job to be processed at a scale of a modern distributed services system is an extremely resource intensive process. In another example, a data scientist may have to spend many hours to extract knowledge and insights from a large set of attributes characterizing processing jobs. Additionally, computer programmers may be required to create and implement rules for processing future jobs based on the knowledge and insights extracted by the data scientist. However, such manual processes that utilize data scientist and computer programmers are exceedingly expensive and impractical in many scenarios, and often error prone leading to suboptimal fraud detection performance.

Adding further complexity, fraudulent activity is constantly evolving and changing, requiring fraud indicators (e.g., attribute values with predictive utility for identifying fraud) to be frequently reevaluated, updated, and/or replaced. For example, new patterns of fraudulent activity, new attack vectors regarding how fraudulent jobs are sent and/or processed by services of a distributed services system, increase complexity in fraud detection. This results in delayed fraud assessments of existing systems having little or no value in preventing many types of fraudulent activity. For example, fraudulent jobs may be sent to a job processing platform in waves and without quick and actionable insights, it is frequently too late to block processing of the fraudulent jobs. Accordingly, many existing systems are forced to rely on generic or historic fraud indicators that are not tailored for new and evolving threats, resulting in ineffective job processing rules. For example, job processing rules that rely on generic or historic fraud indicators are designed to block jobs in a wide variety of illegitimate scenarios while still allowing jobs to be processed in a wide variety of legitimate scenarios. This results in generic rules having suboptimal performance, especially regarding various scenarios that certain merchants may routinely encounter while a majority of merchants rarely or never encounter. These limitations can drastically reduce the attainability and usability of fraud indicators, contributing to systems that are ineffective, excessively rely on manual processes, and have unnecessarily high resource requirements, resulting in ineffective systems, devices, and techniques with limited capabilities.

Accordingly, many embodiments disclosed herein provide resource-efficient and scalable techniques to identify attribute values with predictive utility for identifying jobs involving fraudulent activity and providing real-time, or near-real-time, statistics for the top predictive attribute-value pairs in an accurate, reliable, and actionable manner. For example, the top predictive attribute-value pairs may be presented via a graphical user interface that enables users to quickly generate job processing rules that utilize one or more of the top predictive attribute-value pairs to identifying processing jobs that involve fraudulent activity. In several embodiments, an interaction insight engine may be implemented to analyze job attributes and values to identify indicators of fraud in a fast and actionable manner. Several such embodiments achieve this, at least in part, by breaking the analysis down into an offline phase and an online phase. The offline phase may be performed to generate a ranked list of attribute-value pairs based on the predictively utility of each attribute value for identifying jobs involving fraudulent activity. In many embodiments, by moving the determination of predictive utility offline, insights can be gained without introducing excessive latency. For example, identifying predictive utility for over a hundred attributes with multiple potential values is a resource intensive process. The online phase, on the other hand, may be utilized to generate a set of statistics (also referred to as fresh statistics) for a threshold number of top attribute values in the ranked list. The online and offline phases may enable reduced latency by performing many of the resource intensive portions offline. In several embodiments, the ranked list of attribute-value pairs may be generated on a periodic basis while the set of statistics for the top attribute-value pairs may be generated on demand.

In many embodiments, a server computer system may determine a set of data related to a set of jobs processed by a computing platform on behalf of subscribers to the computing platform as part of an attribute analysis to facilitate the detection of fraudulent activity on a computing platform for processing jobs. The set of data may include, for each job, a set of attribute-value pairs corresponding to a set of attributes utilized to parameterize each job in the set of jobs. The server computer system may transform the data into input data for a machine learning (ML) model executed by the server computer system. In an offline phase of the attribute analysis, the ML model may generate a ranked list of the set of attribute-value pairs based on predictive utility of each attribute-value pair for identifying jobs involving fraudulent activity. The server computer system may identify a request to access information regarding jobs for a particular subscriber to the computing platform and, in response, determine a set of statistics for a threshold number of top attribute-value pairs in the ranked list in an online phase of the attribute analysis. Further, the server computer system may present the set of statistics for the threshold number of top attribute-value pairs via a graphical user interface and generate a job processing rule for the particular subscriber based on user input identifying a top attribute-value pair in the threshold number of top attribute-value pairs.

In these and other ways, components/techniques described herein provide many technical advantages. For instance, the computer-based techniques of the current disclosure increase the accessibility, practicality, adaptability, and availability of real-time, or near-real-time, attribute analysis to facilitate the detection of fraudulent activity resulting from remote job processing requests sent to a distributed services system, thereby improving the functioning of a server systems of the distributed services system for identifying indicators of fraud as well as acting on the indications of fraud to reduce or prevent fraudulent activity as compared to conventional approaches. Additionally, the computer-based techniques of the current disclosure can provide users with a valuable tool for reducing fraudulent jobs and/or false positives (e.g., blocking a legitimate job as fraudulent), resulting in better realization and fewer losses. Accordingly, embodiments disclosed herein can be practically utilized to improve the functioning of a computer and/or to improve a variety of technical fields including job processing by distributed service systems, reducing data latency, improving the accuracy and adaptability of fraud detection, reducing false positives to avoid rejecting legitimate job processing requests, improved confidence is job processing, and/or user experience/capabilities.

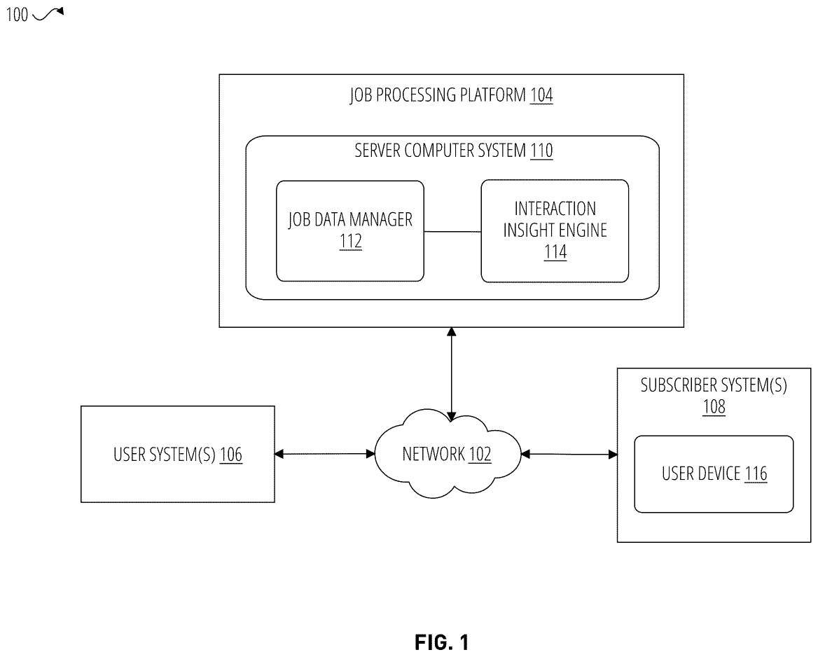

FIG. 1 is a block diagram of an exemplary system architecture 100 for analyzing attribute values to facilitate identification of fraudulent activity according to some embodiments. In one embodiment, the system 100 includes one or more job processing platforms 104, one or more subscriber systems 108, and one or more user systems 106. In one embodiment, one or more systems (e.g., systems 106 and 108) may be mobile computing devices, such as a smartphone, tablet computer, smartwatch, etc., as well computer systems, such as a desktop computer system, laptop computer system, server computer systems, etc. The job processing platforms 104 and subscriber systems 108 may also be one or more computing devices, such as one or more server computer systems, desktop computer systems, etc. Furthermore, there may be any number of user systems 106 and/or subscriber systems 108 utilizing the services of the job processing platforms 104. However, to avoid obscuring the present description, only one job processing platform 104, user system 106, and subscriber system 108 are generally illustrated and described.

Furthermore, it should be appreciated that the embodiments discussed herein may be utilized by a plurality of different types of platform computer server systems, such as inventory platform system(s), media access and control system(s), resource platform system(s), card authorization platform system(s), payment processing platform system(s), gaming platform system(s), social media platform platform(s), and other systems. Then the platform computer server system 104 can include a plurality of service processing systems (not shown) that are distributed systems that perform the functions that provide the one or more services of the platform computer server system 104. In some embodiments, the system 100, or one or more components thereof, may comprise or be included in a distributed services system. Furthermore, any system seeking to detect fraud in a distributed services system may use and/or extend the techniques discussed herein to improve efficiency, scalability, and/or availability of structured data generated based on unstructured data. However, to avoid obscuring the embodiments discussed herein, analysis of job attributes and their values to facilitate the detection of fraudulent activity (e.g., via an interaction insight engine 114), is discussed to illustrate and describe the embodiments of the present invention, and is not intended to limit the application of the techniques described herein to other systems in which structured data generation could be used.

The job processing platform 104, subscriber system 108, and user system 106 may be coupled to a network 102 and communicate with one another using any of the standard protocols for the exchange of information, including secure communication protocols. In one embodiment, one or more of the job processing platform 104, subscriber system 108, and user system 106 may run on one Local Area Network (LAN) and may be incorporated into the same physical or logical system, or different physical or logical systems. Alternatively, the job processing platform 104, subscriber system 108, and user system 106 may reside on different LANs, wide area networks, cellular telephone networks, etc. that may be coupled together via the Internet but separated by firewalls, routers, and/or other network devices. In one embodiment, job processing platform 104 may reside on a single server, or be distributed among different servers, coupled to other devices via a public network (e.g., the Internet) or a private network (e.g., LAN). It should be noted that various other network configurations can be used including, for example, hosted configurations, distributed configurations, centralized configurations, etc.

To analyze job attributes and their values in an efficient, scalable, and actionable manner, in embodiments, job processing platform 104 utilize a server computer system 110 including one or more of a job data manager 112 and an interaction insight engine 114. As will be discussed in greater detail below, the interaction insight engine 114 may utilize data related to jobs processed by the job processing platform 104 and obtained via the job data manager 112 to rank attribute-value pairs based on their predictive utility for identifying jobs involving fraudulent activity and provide a set of statistics (also referred to as fresh statistics) for the top attributes in a real-time, or near-real-time, and actionable manner. In many embodiments, the interaction insight engine 114 may receive input from and communicate output to a user device 116, such as to provide subscribers with fresh statistics for the top attribute-value pairs in a real-time, or near-real-time, and actionable manner. In the illustrated embodiment, the user device 116 is included in the subscriber system 108. However, in additional, or alternative embodiment, the user device 116 may be included in user system 106 and/or job processing platform 104 without departing from the scope of this disclosure. In some examples, the job data manager 112 and interaction insight engine 114 operate substantially independently from each other. Thus, one or more embodiments described herein generally decouple capturing and storing of data related to the processing of jobs (which may be performed by job data manager 112) and determination of the list of ranked attribute-value pairs and the fresh statistics for the top ranked attribute-value pairs (which may be performed by interaction insight engine 114). For example, the set of statistics, or fresh statistics, may include percentages, monetary values, and counts for fraudulent and legitimate jobs for each of the top ranked attribute-value pairs.

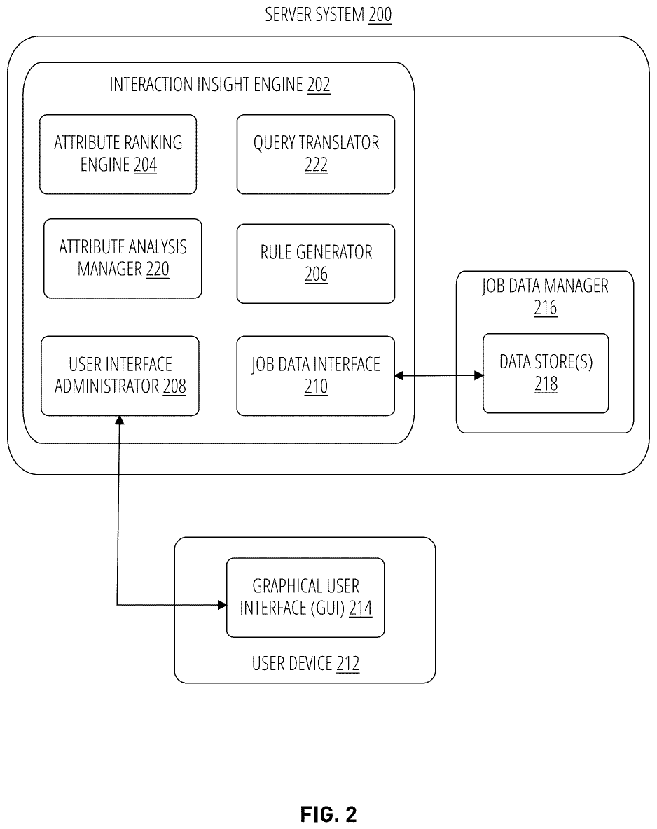

FIG. 2 illustrates various aspects of a server system 200 including an interaction insight engine 202 according to some embodiments. In the illustrated embodiment, the server system 200 includes the interaction insight engine 202 and a job data manager 216. The interaction insight engine 202 is communicatively coupled to a user device 212 and the job data manager 216. The interaction insight engine 202 includes an attribute ranking engine 204, a rule generator 206, a user interface administrator 208, and a job data interface 210. The user device 212 includes a GUI 214 that is communicatively couplable to the interaction insight engine 202 via user interface administrator 208 and the job data manager 216 includes one or more datastores 218 that are communicatively couplable to the interaction insight engine 202 via job data interface 210. In various embodiments, the interaction insight engine 202 may perform attribute analysis using data obtained from datastore 218 of job data manager 216 to rank a set of attribute-value pairs parameterizing jobs in a set of jobs based on predictive utility of each attribute value for detecting jobs involving fraudulent activity and presenting the top attribute-value pairs in the ranked list along with fresh statistics for the top attribute-value pairs.

It will be appreciated that one or more components of FIG. 2 may be the same or similar to one or more other components disclosed herein. For example, interaction insight engine 202 and/or job data manager 216 may be the same or similar to interaction insight engine 114 and/or job data manager 112, respectively. In another example, user device 212 may be the same or similar to user device 116. Further, aspects discussed with respect to various components in FIG. 2 may be implemented by one or more other components from one or more other embodiments without departing from the scope of this disclosure. For example, job data manager 216 and/or datastore 218 may be implemented by components external to the server system 200, such as components of job processing platform 104 without departing from the scope of this disclosure. In another example, the query translator 222 may be included in the attribute analysis manager 220 without departing from the scope of this disclosure. Embodiments are not limited in this context.

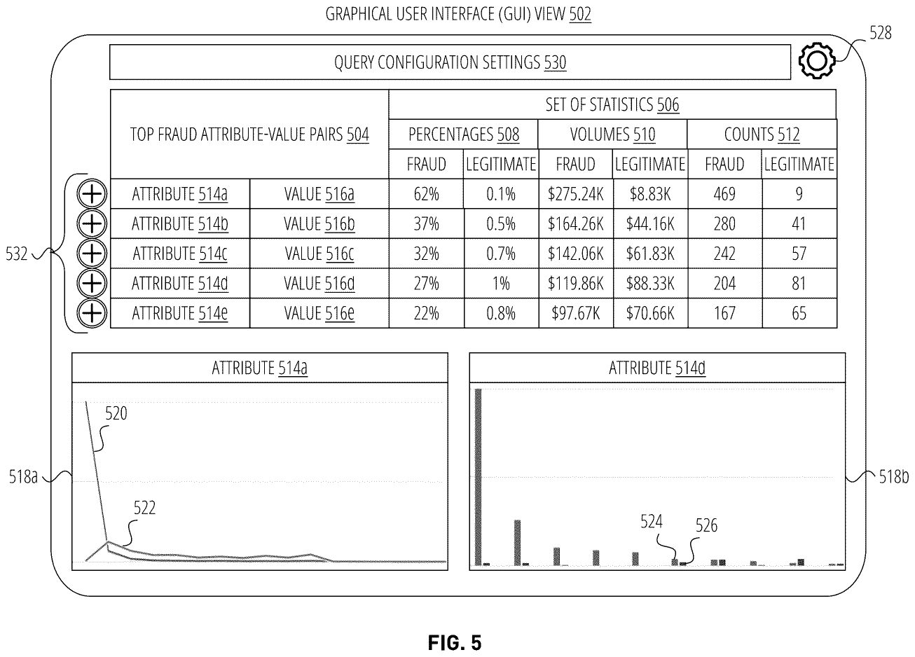

Generally, the components of interaction insight engine 202 implement techniques for providing relevant and actionable insights regarding fraudulent activity in real-time or near-real-time. In many embodiments, this may take the form of a ranked list of top attribute-value pairs for indicating jobs involving fraudulent activity. In many embodiments, the ranked list of top attribute-value pairs may be generated using offline data from datastore 218. Further, the top attribute-value pairs may be presented along with fresh statistics via the GUI 214, such as to a subscriber. For example, the fresh statistics, also referred to as the set of statistics, may correspond to real-time values of fraudulent and legitimate jobs for the attribute-value pairs that are acquired on-demand, such as based on a subscriber's date range and filters applied. For example, percentages, monetary values, and counts for fraudulent and legitimate jobs may be presented (see e.g., FIG. 5), such as for a selected date range of jobs.

In various embodiments, the datastore 218 may include a first datastore for storing offline data (e.g., historical data) and a second datastore for storing online data. In some embodiments, the first datastore for storing offline data may include a data warehouse and the second datastore for storing online data may utilize online analytical processing (OLAP). In either event, the second datastore for storing online data may have lower latency than the first datastore for storing offline data. In some embodiments, rules for processing jobs may be intuitively created and automatically implemented based on the top attribute values. These job processing rules may be directed to blocking (or allowing) jobs to process.

As shown in FIG. 2, the interaction insight engine 202 includes attribute ranking engine 204, query translator 222, attribute analysis manager 220, rule generator 206, user interface administrator 208, and job data interface 210. The user interface administrator 208 may facilitate interaction between the interaction insight engine 202 and the GUI 214 of user device 212. Accordingly, in various embodiments, the user interface administrator 208 may generate and transmit data that configures the GUI 214 to render information relevant to the attribute analysis process as well as received input from a user relevant to the attribute analysis process and/or rule generation. For example, user interface administrator 208 may generate data based on output of attribute analysis manager 220 to cause GUI 214 to display the ranked attribute-value pair list and/or charts illustrating legitimate jobs and fraudulent jobs for one or more of the ranked attribute-value pair list (see e.g., FIG. 5). In some embodiments, a user may configure settings for and contents of the GUI 214 via the user interface administrator 208 (e.g., the contents of GUI view 502 of FIG. 5). The job data interface 210 may facilitate retrieval, identification, and/or storage of job-related data utilized by the interaction insight engine 202. Accordingly, in many embodiments, the job data interface 210 may interact with job data manager 216 to retrieve, identify, and/or store job-related data from datastore 218 in support of analysis of attributes to facilitate the detection of fraudulent activity by interaction insight engine 202. In one embodiment, the job data manager 216 may comprise, or be included in, a data platform.

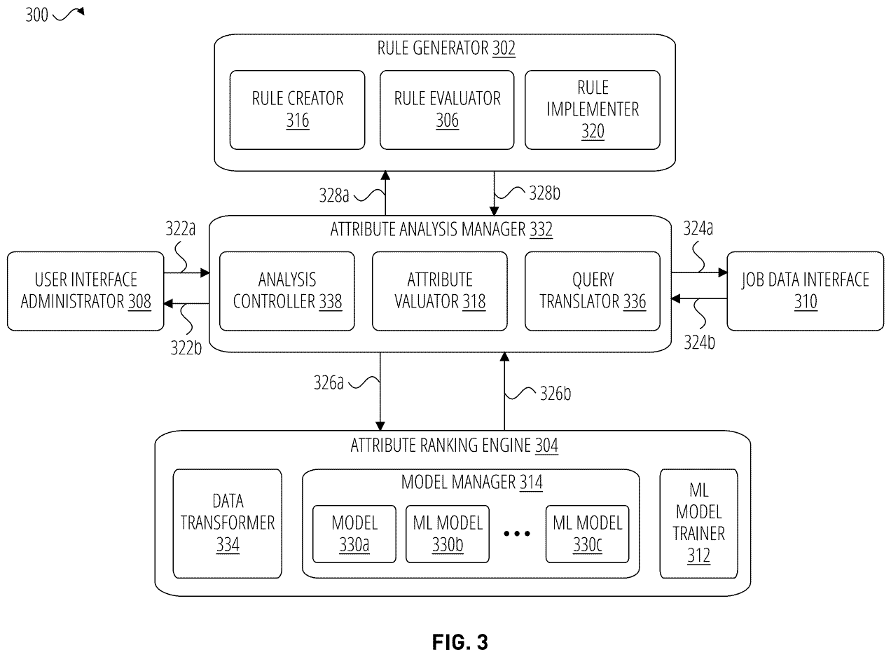

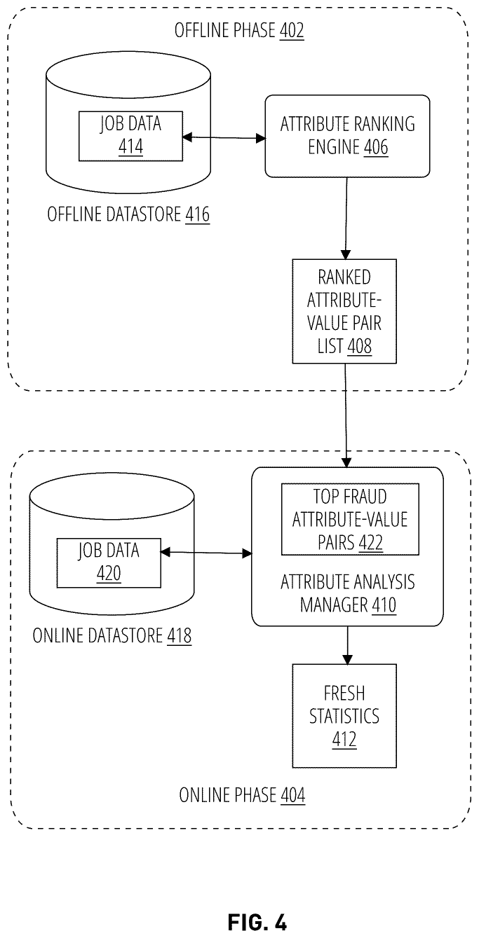

The attribute ranking engine 204 may generally operate to identify one or more predictive attribute-value pairs from a set of attributes corresponding to a set of jobs. In many embodiments, the one or more predictive attributes may include one or more attributes in the set of attributes that are determined to be indicative of jobs that involve fraudulent activity, such as spoofing or stolen credentials. Various aspects of the attributes and attribute analyzers disclosed hereby (e.g., attribute ranking engine 204) will be described in more detail below, such as with respect to FIG. 3 and FIG. 4).

The rule generator 206 may generally operate to generate a job processing rule based on jobs, attributes, attribute values, user input, and the like. In many embodiments, the rule generator 206 may interact with other components of the interaction insight engine 202 during the process of generating a rule. For example, rule generator 206 may interact with attribute ranking engine 204 to determine predictive attribute-value pairs. In another example, rule generator 206 may interact with attribute analysis manager 220 to determine a set of jobs and/or attribute-value pairs for the set of jobs. In various embodiments, the rule generator 206 may generate a heuristic job processing rule based on based on jobs, attributes, attribute values, and user input (e.g., selection of attributes and/or values for the selected attributes). For example, rule generator 206 may generate a heuristic rule that blocks jobs (or allows jobs) that include one or more attributes with one or more values (or ranges of values or sets of discrete values). Various aspects of rule generators disclosed hereby (e.g., rule generator 206) will be described in more detail below, such as with respect to FIG. 3.

FIG. 3 illustrates an exemplary process flow 300 for attribute analysis according to some embodiments. The illustrated embodiment includes an attribute analysis manager 332, an attribute ranking engine 304, a rule generator 302, a user interface administrator 308, and a job data interface 310. The attribute analysis manager 332 may include an analysis controller 338, an attribute valuator 318, and a query translator 336. The attribute ranking engine 304 may include a data transformer 334, a model manager 314, and a machine learning (ML) model trainer 312. The rule generator 302 may include a rule creator 316, a rule evaluator 306, and a rule implementer 320.

In various embodiments, the components of the attribute analysis manager 332, attribute ranking engine 304, and rule generator 302 may operate in conjunction to identify attribute values with predictive utility for identifying fraudulent activity, provide real-time statistics for the identified attribute values, and enabling generation of job processing rules based on the identified attributes. It will be appreciated that one or more components of FIG. 3 may be the same or similar to one or more other components disclosed herein. For example, one or more of attribute analysis manager 332, attribute ranking engine 304, and rule generator 302 may be the same or similar to one or more of attribute analysis manager 220, attribute ranking engine 204, and rule generator 206, respectively. Further, aspects discussed with respect to various components in FIG. 3 may be implemented by one or more other components from one or more other embodiments without departing from the scope of this disclosure. For example, query translator 336 may be implemented separately from attribute analysis manager 332 without departing from the scope of this disclosure. Embodiments are not limited in this context.

The components of FIG. 3 may generally be used to identify attribute-value pairs that are indicative of fraud in a quick and actionable manner that facilitates generation of one or more job processing rules. These operations may be coordinated by the attribute analysis manager 332, which is communicatively coupled to the attribute ranking engine 304, the rule generator 302, the user interface administrator 308, and the job data interface 310. As discussed in more detail below, many of these operations may be based on one or more inputs and one or more outputs exchanged between the different components. For example, one or more inputs 322a may be received from a user (e.g., a user of the services of a distributed services system) via user interface administrator 308. Additionally, many operations may produce one or more outputs 322b that are presented, or used to generate data to configure a user interface to present data, to users, such as via a GUI. These inputs and outputs may be the same or similar to those described with respect to FIG. 5. Further, many of these operations may cause the attribute analysis manager 332 to generate one or more inputs 324a for the job data interface 310 and, in response, receive one or more outputs 324b from the job data interface 310.

The attribute analysis manager 332 may generally operate to coordinate operations associated with analyzing attributes to facilitate the detection of fraudulent activity associated with the processing of jobs. For example, attribute analysis manager 332 may be responsible for determining how to handle various inputs received from other components. In one such example, the analysis controller 338 of the attribute analysis manager 332 may determine a threshold number of top attribute-value pairs to be presented via the user interface. In some such examples, the threshold number of top attributes (e.g., 4, 5, 6, 7, 8, 10, etc.) to be presented may be determined by the analysis controller 338 based on user input and/or predetermined settings.

In various embodiments, the analysis controller 338 may trigger the operation of other components. For example, analysis controller 338 may trigger performance of an offline phase by attribute ranking engine 304 to generate a ranked list of attribute-value pairs. In some such examples, this may occur on a periodic basis, such as weekly, monthly, yearly, etc. In another example, analysis controller 338 may trigger the attribute valuator 318 to retrieve and/or generate fresh values for a threshold number of top attribute-value pairs, such as by generating inputs 324a for job data interface 310. In various such examples, this may occur in response to inputs 322a received from user interface administrator 308. In yet another example, the analysis controller 338 may cause query translator 336 to transform inputs 322a into one or more of inputs 328a, inputs 324a, and inputs 326a.

In some such examples, the analysis controller 338 may provide data along with an indication of the destination to the query translator 336 and, in response, the query translator 336 may transform the data into the appropriate format and communicate it to the destination. In yet another example, analysis controller 338 may trigger attribute ranking engine 304 to generate a ranked list of attribute-value pairs based on a request (e.g., included in inputs 322a) to access information regarding jobs for a particular subscriber to the computing platform. In some embodiments, attribute analysis manager 332 may send one or more inputs 326a and receive one or more outputs 326b from attribute ranking engine 304 to determine predictive attributes.

In various embodiments, the attribute ranking engine 304 may operate to identify one or more predictive attribute values from a set of attributes corresponding to a set of jobs. For example, attribute analysis manager 332 may provide a ranked list of a set of attribute-value pairs based on predictive utility of each attribute value for identifying jobs involving fraudulent activity. In many embodiments, the one or more predictive attribute values may include one or more attribute values in the set of attributes that are determined to be indicative of jobs that include or involve fraudulent activity. In some embodiments, the attribute ranking engine 304 may utilize job data that includes labels that indicate whether each job in the job data is fraudulent or legitimate to identify particular attributes and/or values for the attributes that are indicative of fraud. In many embodiments, the ranked attribute-value pair list may include or refer to attribute values that identify the most fraud at the lowest cost of legitimate jobs blocked. Analysis controller 338 may communicate the set of jobs and corresponding attribute-value pairs to the attribute ranking engine 304 as inputs 326a. In response, the data transformer 334 may embed the data for each job into a vector space. For example, the vector space may include a different dimension for each attribute. Further, the data transformer 334 may normalize values for each dimension. For example, each attribute value may be transformed into a value between zero and one. More generally, the data transformer 334 may translate the job data into a format expected by the model and/or model manager 314. In various embodiments, ML models may or may not be utilized. For example, static analysis with heuristics may be utilized instead of a ML model. In such examples, all the jobs that match may be summed up and the count of fraudulent versus legitimate totals may be calculated, then be sorted by the percent of jobs with that value that are fraudulent.

The attribute ranking engine 304 may utilize ML model trainer 312 and/or one or more ML models 330a, 330b, 330c (collectively referred to as ML models 434) to determine attribute values in the set of attributes that are indicative of jobs involving fraudulent activity. For example, if a portion of a set of jobs are labeled as fraudulent, the ML model trainer 312 of attribute ranking engine 304 may train an ML model (e.g., ML model 330b) against the available attribute-value pairs in the attribute set. In many embodiments, the ML model may be trained to identify correlations between attribute-value pairs and jobs identified (e.g., labeled) as fraudulent. The ML model 330b may then be utilized to identify predictive attributes in the set of attributes for fraudulent activity. In various embodiments, the ML model may include at least one of a neural network model, a decision tree model, a generative model, linear regression model, a random forest model, a naïve bayes model, and the like. For example, a random forest may be utilized to generate attribute to value bucket pairs. The random forest may facilitate the combination of multiple attribute to value bucket pairs together into one predictive rule. In some embodiments, the ML model may include an ensemble of one or more different ML models.

The predictive attribute-value pairs may be returned to attribute analysis manager 332 as outputs 326b and then a threshold number of top attribute-value pairs may be communicated to the user via outputs 322b to user interface administrator 308. Prior to outputting the top predictive attribute-value pairs, the analysis controller 338 may cause the attribute valuator 318 to generate fresh values for the top predictive attribute-value pairs. For example, attribute valuator 318 may utilize job data interface 310 to retrieve real-time, or near-real-time statistics for each of the top predictive attribute-value pairs for jobs performed in a preceding period of time (e.g., the last 12 hours, last 7 days, between 7 and 14 days ago, etc.) and/or based on various filters. These statistics may include, for example, percentages, values, and/or counts of legitimate and fraudulent jobs (see e.g., FIG. 5). In various embodiments, the preceding period of time may be determined based on user input.

In some embodiments, a prediction utility score may be determined for each of the attribute-value pairs. The prediction utility score may indicate how closely an attribute and/or values for the attribute correlate with fraudulent activity. The prediction utility score may be utilized to rank the attribute-value pairs and identify one or more attribute values with the top prediction utility scores. For example, analysis controller 338 may apply a threshold to the prediction utility scores and only present attribute-value pairs with prediction utility scores above the threshold to the user for selection. In another example, the attribute valuator 318 may present a threshold number of attribute-value pairs having the highest prediction utility scores. In many embodiments, predictive attributes may be presented via a GUI for selection of one or more to base generation of the job processing rule (see e.g., FIG. 5). Additionally, the attribute valuator 318 may determine values fresh statistics for the top fraud attribute-value pairs and fresh statistics for them.

The set of attributes for a job may include various information related to the job, such as outcomes, processes, rules, and identifying information associated with a job. For example, attributes may include one or more of the following: a job identifier, a parent job identifier, a job type, a charge identifier, timestamps for various operations, a payment method type, a merchant identifier, a platform identifier, a destination identifier, a live mode indicator, an event creation timestamp, an event version, a charge creation timestamp, a computed/predicted outcome, bank identification number (BIN), a refund identifier, a refund visibility, a refund reason, a dispute identifier, a dispute visibility, a dispute reason, an early fraud warning indicator, a fraud analysis outcome, a fraud analysis performance indicator, previously fraudulent activity, a gateway outcome, a gateway outcome reason, a blocking reason, authentication indicator, job details, user or job details (e.g., email address, street address, IP address, location of IP address, etc.), metadata details, rules applied, analyses performed, amount of time one or more attributes have been known (e.g., time since first seeing an identifier associated with a job, such as an email address or card number) and the like. In some embodiments, each job may correspond to an exchange between a subscriber to the computing platform and a client of the subscriber to the computing platform. Additionally, attributes may have various types of values, such as numerical, alphanumeric, structured, unstructured, categorical, Boolean, and the like. In some embodiments, the various types of values may be normalized (e.g., by data transformer 334).

As previously mentioned, the top predictive attribute-value pairs may be presented via a user interface. In various embodiments, the top predictive attributes may be presented in a manner that allows one or more to be selected for rule generation. Once the one or more predictive attribute-value pairs have been selected, the attribute analysis manager 332 may generate one or more inputs 328a and receive one or more outputs 328b from rule generator 302 regarding the creation, evaluation, and/or implementation of the resulting rule. In some embodiments, rule evaluator 306 may determine various performance characteristics of values and/or ranges of values of the resulting rule. The performance characteristics determined by the rule evaluator 306 may be presented to the user to assist the user in evaluating performance of the rule and determining whether to modify and/or implement the rule. This process may be repeated for each of the selected predictive attribute-value pairs. After values have been determined for each of the selected predictive attributes, the rule creator 316 may generate a heuristic job processing rule based on the selected predictive attribute-value pairs and/or the selected values for the selected predictive attribute-value pairs. In various embodiments, the generated job processing rule may block and/or unblock jobs. For example, if an existing rule allows a job to be performed, the job processing rule may determine to block performance of that job. In another example, if an existing rule blocks a job, the job processing rule may determine to allow performance of that job. In many embodiments, performance characteristics of the generated heuristic job processing rule may also be determined and presented to the user. If the performance of the job processing rule is accepted by the user, the rule implementer 320 may be utilized to implement the job processing rule for blocking and/or unblocking future jobs.

More generally, the rule generator 302 may operate to generate, evaluate, and/or implement a job processing rule based on jobs, attributes, attribute values, user input, and the like. In the illustrated embodiment, the rule generator 302 includes rule creator 316, rule evaluator 306, and a rule implementer 320. In various embodiments, the rule creator 316 of rule generator 302 may generate a heuristic job processing rule based on based on jobs, attributes, attribute values, and user input (e.g., selection of attributes and/or values for the selected attributes). In various such embodiments, the rule creator 316 may generate a heuristic rule that blocks jobs (or allows jobs) that include one or more attributes with one or more values (or ranges of values or sets of discrete values). In many embodiments, the components of rule generator 302 may interact with each other and/or one or more of attribute ranking engine 304, attribute analysis manager 332, user interface administrator 308, and job data interface 310 during the process of generating, evaluating, and/or implementing a rule.

The rule evaluator 306 may generally operate to analyze performance of a job processing rule, such as a job processing rule created by rule creator 316. In various embodiments, the rule evaluator 306 may support testing of job processing rules, such as on historical jobs and/or the set of jobs utilized to generate the rule. Additionally, or alternatively, the rule evaluator 306 may determine various metrics that characterize performance of a job processing rule. For example, the rule evaluator 306 may determine blocked jobs, unblocked jobs, previously blocked jobs, previously unblocked jobs, blocking rates, false positive rates, and the like. In some embodiments, the rule evaluator 306 may include a performance analyzer and an analytics engine that operates to analyze performance of a predictive attribute-value pairs and job processing rules, such as predictive attribute-value pairs determined by attribute ranking engine 304 and/or a job processing rule generated by rule creator 316. The performance analyzer may support testing of predictive attribute-value pairs and/or predictive job processing rules, such as on historical jobs (e.g., the previous 6 months of jobs) and/or the set of jobs being utilized to generate the rule. In various embodiments, the range of the historical jobs may be determined based on user input (e.g., a selection of 2, 4, 6, 8, 10, or 12 months).

Additionally, the rule evaluator 306 may determine various metrics that characterize performance of a job processing rule. For example, the rule evaluator 306 may determine blocked jobs, unblocked jobs, previously blocked jobs, previously unblocked (i.e., allowed) jobs, previously allowed but identified as suspicious jobs, and the like. The previously allowed but identified as suspicious jobs may correspond to jobs that were flagged as suspicious (e.g., an early fraud warning) when originally processed by a previously existing rule. The rule evaluator 306 or attribute valuator 318 may determine statistics (e.g., performance metrics) for attribute-value pairs and job processing rules. For example, rule evaluator 306 may determine one or more of blocking rates, a number of false positives, false positive rates, various percentages, various job counts, and the like. Blocking rates may include a number of blocked jobs divided by the total number of jobs in the set of jobs. False positives may correspond to legitimate jobs that are blocked by the job processing rule or illegitimate jobs that are unblocked by the job processing rule. False positive rates may include the number of jobs with non-target labels that were blocked (or unblocked) divided by the total number of blocked (or unblocked) jobs. In another example, rule evaluator 306 may determine a value and/or number of jobs in one or more sets of jobs (e.g., a value of the blocked jobs determined to be false positives).

FIG. 4 illustrates exemplary aspects of an offline phase 402 and an online phase 404 of analyzing attributes according to some embodiments. In the illustrated embodiment, the offline phase 402 includes an offline datastore 416 and an attribute ranking engine 406 and the online phase 404 includes an online datastore 418 and an attribute analysis manager 410. In some embodiments, the attribute ranking engine 406 may be the same or similar to attribute ranking engine 204. In various embodiments, the attribute analysis manager 410 may be the same or similar to attribute analysis manager 220.

In various embodiments described hereby, the offline phase 402 is utilized to generate the ranked attribute-value pair list 408 and the online phase 404 is utilized to generate fresh statistics 412 for the top fraud attribute-value pairs 422. In many embodiment, by separating analysis of attributes into the offline phase 402 and the online phase 404, fraud assessments can be performed in a quick and actionable manner because computationally resource intensive operations are performed outside of a job processing path where time and/or resource usage has less influence on the efficiency of fraud detection. Furthermore, the online phase can therefore utilize more computationally and resource efficient operations to provide real time or near real time fraud analysis for jobs, as discussed herein. Therefore, an improved technique for analyzing attributes to gain insights for facilitating the prevention of fraudulent activity in a quick and actionable manner is enabled by the techniques and components described hereby.

It will be appreciated that one or more components of FIG. 4 may be the same or similar to one or more other components disclosed herein. For example, one or more of attribute ranking engine 406 and/or attribute analysis manager 410 may be the same or similar to attribute ranking engine 304 and/or attribute analysis manager 332, respectively. In another example, offline datastore 416 may include a first datastore of datastores 218 and online datastore 418 may include a second data store of datastore 218. Further, aspects discussed with respect to various components in FIG. 4 may be implemented by one or more other components from one or more other embodiments without departing from the scope of this disclosure. For example, attribute analysis manager 410 may be utilized in at least a portion of the offline phase 402, such as to periodically trigger operation of attribute ranking engine 406 without departing from the scope of this disclosure. Embodiments are not limited in this context.

Generally, the attribute ranking engine 406 may obtain job data 414 from offline datastore 416. For example, job data 414 may include a set of data related to a set of jobs processed by a computing platform on behalf of subscribers to the computing platform (e.g., job processing platform 104). In one embodiment, subscribers may include merchants and the computing platform may include a job processing platform. The job data 414 may include, for each job, a set of values to a set of attributes utilized to parameterize each job in the set of jobs. The attribute ranking engine 406 may transform the job data 414 into input data for an ML model and the ML model may generate ranked attribute-value pair list 408 based on the predictive utility of each attribute value for identifying jobs involving fraudulent activity.

The ranked attribute-value pair list 408 may be provided to the attribute analysis manager 410 in the online phase 404 for determination of the top fraud attribute-value pairs 422. The top fraud attribute-value pairs 422 may include a threshold number of top attributes in the ranked attribute-value pair list 408. For example, the top five attribute-value pairs may be included in the ranked attribute-value pair list 408. Further, the top fraud attribute-value pairs 422 may correspond to the fraud attribute-value pairs 422 with the highest predictive utility. The attribute analysis manager 410 may obtain job data 420 from online datastore 418 based on the top fraud attribute-value pairs 422 and generate fresh statistics 412 for the top fraud attribute-value pairs 422 based on the job data 420. In many embodiments, the fresh statistics 412 may correspond to real-time, or near-real-time values for the top fraud attribute-value pairs 422.

FIG. 5 illustrates various aspects of an exemplary GUI view 502 of top fraud attribute-value pairs according to some embodiments. The GUI view 502 provides in an improved user interface for electronic devices at least through the specific manners of providing (e.g., by displaying) an interactive experience that facilitates identification and evaluation of top fraud attribute-value pairs for jobs, as well as for the generation, testing, and/or implementation of customized job processing rules based on the top fraud attribute-value pairs in an intuitive and efficient manner that determines and presents relevant information and functionalities to users, as described in more detail below.

For example, the GUI view 502 may provide a specific improvement over existing systems by displaying top predictive attributes with relevant metrics along with other relevant data to assist a user in selecting attributes to use in generating a job processing rule for preventing processing of jobs involving fraudulent activity. The data presented in GUI view 502 may be generated by one or more components of an interaction insight engine disclosed and described hereby. It will be appreciated that one or more components of FIG. 5 may be the same or similar to one or more other components disclosed herein. For example, the GUI view 502 may be presented via user device 116 and/or GUI 214 of user device 212. Further, aspects discussed with respect to various components in FIG. 5 may be implemented by one or more other components from one or more other embodiments without departing from the scope of this disclosure. Embodiments are not limited in this context.

Referring to FIG. 5, GUI view 502 includes top fraud attribute-value pairs 504 including attributes 514a, 514b, 514c, 514d, 514e (collectively referred to as attributes 514) and values 516a, 516b, 516c, 516d, 516e (collectively referred to as values 516), a set of statistics 506 (also referred to as fresh statistics) including percentages 508, volumes 510, and counts 512 for fraudulent and legitimate jobs, charts 518a, 518b (collectively referred to as charts 518), rule creation icons 532, query configuration settings 530, and settings icon 528. The query configuration settings 530 may display the current filters (e.g., time period) utilized to generate the set of statistics 506. The query configuration settings 530 may be configured via the settings icon 528. Additionally, various parameters, filters, and thresholds (e.g., the threshold number of top attribute-value pairs, basis for fresh statistics (e.g., time period), and the like) may be configured via the settings icon 528. The charts 518 may show a plot of legitimate and fraudulent jobs for selected attributes. For example, clicking on a particular attribute-value pair may cause a chart to be populated based on the set of statistics 506. In the illustrated embodiment, chart 518a corresponds to attribute 514a and a range of values for the attribute with a plot of legitimate jobs 520 and fraudulent jobs 522 for the range of values. Similarly, chart 518b corresponds to attribute 514d and includes a range of values for the attribute with a plot of fraudulent jobs 524 and legitimate jobs 526 for the range of values. In some embodiments, the charts may enable a user to readily determine the predictive value of a top fraud-attribute pair as compared to other values for the attribute.

In various embodiments, a user may generate a rule for a particular attribute-value pair in an intuitive manner by selecting one of the rule creation icons 532. For example, a user may cause the server computer system to create and implement a heuristic job processing rule that blocks unprocessed transactions that include the attribute-value pair associated with the respective rule creation icon. In various embodiments, a heuristic job processing rule may be created by selecting multiple ones of the attribute-value pairs. In various such embodiments, unprocessed jobs that include each of the selected attribute-value pairs may be blocked. In some embodiments, Boolean logic may be utilized to implement a job processing rule based on multiple ones of the attribute-value pairs. For example, a heuristic job processing rule may block unprocessed jobs that include a first attribute-value pair OR a second attribute-value pair. In this manner, a user may create custom rules for blocking fraudulent jobs based on specific parameters (e.g., attribute-value pairs) they identify via the GUI. The volumes 510 may correspond to monetary values of the fraudulent and legitimate jobs.

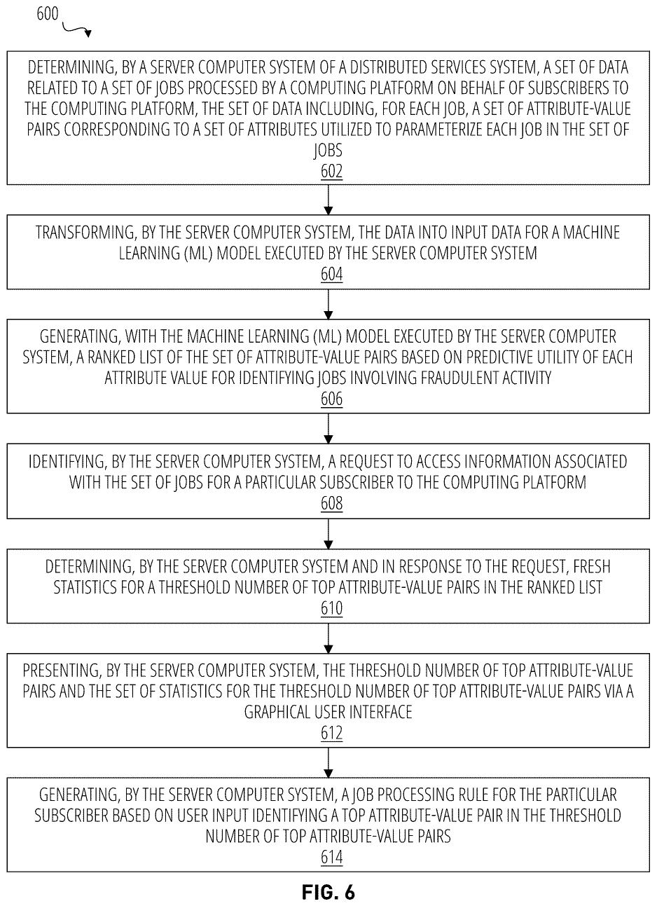

FIG. 6 illustrates a logic flow 600 of a method for attribute analysis to facilitate the detection of fraudulent activity according to some embodiments. The logic flow 600 is performed by processing logic that may comprise hardware (circuitry, dedicated logic, etc.), software (such as is run on a general purpose computer system or a dedicated machine), firmware, or a combination. In various embodiments, the logic flow 600 is performed by one or more of a commerce platform system (e.g., job processing platform 104), a server system (e.g., server computer system 110 or server system 200), and a interaction insight engine (e.g., interaction insight engine 114). Embodiments are not limited in this context.

Referring to FIG. 6, the logic flow 600 begins at block 602. At block 602, a set of data related to a set of jobs processed by a computing platform on behalf of subscribers to the computing platform may be determined by a server computer system of a distributed services system. The set of data may include, for each job, a set of attribute-value pairs corresponding to a set of attributes utilized to parameterize each job in the set of jobs. For example, job data 414 may be determined by attribute ranking engine 406 in the offline phase 402.

At block 604 the data may be transformed, by the server computer system, into input data for a machine learning (ML) model executed by the server computer system. For example, data transformer 334 may convert job data into input data for ML model 330a.

Proceeding to block 606, the machine learning (ML) model executed by the server computer system may generate a ranked list of the set of attribute-value pairs based on predictive utility of each attribute value for identifying jobs involving fraudulent activity. For example, an ML model of attribute ranking engine 406 may transform job data 414 into ranked attribute-value pair list 408.

Continuing to block 608, a request to access information associated with the set of jobs for a particular subscriber to the computing platform may be identified by the server computer system. For example, analysis controller 338 may identify a request to access information regarding jobs for a particular subscriber to the computing platform based on inputs 322a received via user interface administrator 308.

At block 610, a set of statistics may be determined for a threshold number of top attribute-value pairs in the ranked list by the server computer system in response to the request. For example, attribute analysis manager 410 may determine fresh statistics 412 for the top fraud attribute-value pairs 422.

Proceeding to block 612, the threshold number of top attribute-value pairs and the set of statistics for the threshold number of top attribute-value pairs may be presented via a graphical user interface by the server computer system. For example, the GUI view 502 may be presented via GUI 214 and include top fraud attribute-value pairs 504.

At block 614, a job processing rule for the particular subscriber may be generated by the server computer system based on user input identifying a top attribute-value pair in the threshold number of top attribute-value pairs. For example, a job processing rule for attribute 514a and value 516a may be generated in response to user input selecting the corresponding rule creation icon 532.

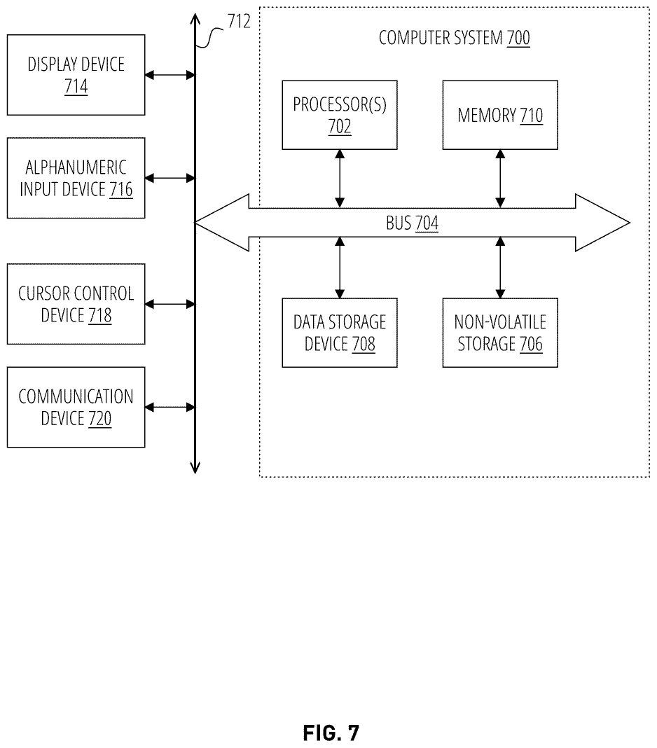

FIG. 7 is one embodiment of a computer system that may be used to support the systems and operations discussed herein. For example, the computer system illustrated in FIG. 7 may be used by a platform system, a server system, a job data pipeline, a subscriber system, a user system, etc. It will be apparent to those of ordinary skill in the art, however that other alternative systems of various system architectures may also be used.

The data processing system illustrated in FIG. 7 includes a bus or other internal communication means 704 for communicating information, and one or more processors 702 coupled to the bus 704 for processing information. The system further comprises a random access memory (RAM) or other volatile storage device (referred to as memory 710), coupled to bus 704 for storing information and instructions to be executed by processor 702. Memory 710 (e.g., main memory) also may be used for storing temporary variables or other intermediate information during execution of instructions by processor 702. The system also comprises non-volatile storage 706 (e.g., read only memory (ROM) and/or static storage device) coupled to bus 704 for storing static information and instructions for processor 702, and a data storage device 708 such as a magnetic disk or optical disk and its corresponding disk drive. Data storage device 708 is coupled to bus 704 for storing information and instructions.

The system may further be coupled to a display device 714, such as a light emitting diode (LED) display or a liquid crystal display (LCD) coupled to bus 704 through bus 712 for displaying information to a computer user. An alphanumeric input device 716, including alphanumeric and other keys, may also be coupled to bus 704 through bus 712 for communicating information and command selections to processor 702. An additional user input device is cursor control device 718, such as a touchpad, mouse, a trackball, stylus, or cursor direction keys coupled to bus 704 through bus 712 for communicating direction information and command selections to processor 702, and for controlling cursor movement on display device 714.

Another device, which may optionally be coupled to computer system 700, is a communication device 720 for accessing other nodes of a distributed system via a network. The communication device 720 may include any of a number of commercially available networking peripheral devices such as those used for coupling to an Ethernet, token ring, Internet, or wide area network. The communication device 720 may further be a null-modem connection, or any other mechanism that provides connectivity between the computer system 700 and the outside world. Note that any or all of the components of this system illustrated in FIG. 7 and associated hardware may be used in various embodiments as discussed herein.

It will be appreciated by those of ordinary skill in the art that any configuration of the system may be used for various purposes according to the particular implementation. The control logic or software implementing the described embodiments can be stored in memory 710 (e.g., main memory), data storage device 708 (e.g., mass storage device), non-volatile storage 706 (e.g., ROM), or other storage medium locally or remotely accessible to processor 702.

It will be apparent to those of ordinary skill in the art that the system, method, and process described herein can be implemented as software stored in memory 710, non-volatile storage 706, and/or data storage device 708 and executed by processor 702. This control logic or software may also be resident on an article of manufacture comprising a computer readable medium having computer readable program code embodied therein and being readable by the data storage device 708 and for causing the processor 702 to operate in accordance with the methods and teachings herein.

The embodiments discussed herein may also be embodied in a handheld or portable device containing a subset of the computer hardware components described above. For example, the handheld device may be configured to contain only the bus 704, the processor 702, and memory 710 and/or non-volatile storage 706. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of embodiments for such a device would be apparent to one of ordinary skill in the art given the disclosure as provided herein.

The embodiments discussed herein may also be embodied in a special purpose appliance including a subset of the computer hardware components described above. For example, the appliance may include a processor 702, a data storage device 708, a bus 704, and memory 710, and only rudimentary communications mechanisms, such as a small touch-screen that permits the user to communicate in a basic manner with the device. In general, the more special-purpose the device is, the fewer of the elements need be present for the device to function.

There are a number of example embodiments described herein.
Example 1 is a method for method for obtaining insights from detected fraudulent activity in a distributed services system, the method comprising, the method comprising: determining, by a server computer system of the distributed services system, a set of data related to a set of jobs processed by a computing platform on behalf of subscribers to the computing platform, the set of data including, for each job, a set of attribute-value pairs corresponding to a set of attributes utilized to parameterize each job in the set of jobs; transforming, by the server computer system, the data into input data for a machine learning (ML) model executed by the server computer system; generating, with the machine learning (ML) model executed by the server computer system, a ranked list of the set of attribute-value pairs based on predictive utility of each attribute value for identifying jobs involving fraudulent activity; identifying, by the server computer system, a request to access information associated with the set of jobs for a particular subscriber to the computing platform; determining, by the server computer system and in response to the request, a set of statistics for a threshold number of top attribute-value pairs in the ranked list; presenting, by the server computer system, the threshold number of top attribute-value pairs and the set of statistics for the threshold number of top attribute-value pairs via a graphical user interface; and generating, by the server computer system, a job processing rule for the particular subscriber based on user input identifying a top attribute-value pair in the threshold number of top attribute-value pairs.
Example 2 is the method of Example 1, that may optionally include: identifying, by the server computer system, an unprocessed job; and blocking, by the server computer system, processing of the unprocessed job based on the job processing rule.
Example 3 is the method of Example 2, that may optionally include that blocking processing of the unprocessed job based on the job processing rule is in response to determining that the unprocessed job includes the top attribute-value pair identified based on user input.
Example 4 is the method of Example 1, that may optionally include: identifying, by the server computer system, an unprocessed job; and processing, by the server computer system, the unprocessed job based on the job processing rule.
Example 5 is the method of Example 1, that may optionally include that the ranked list of the set of attribute-value pairs is generated in an offline phase and the set of statistics are generated in an online phase.
Example 6 is the method of Example 1, that may optionally include that the ranked list of the set of attribute-value pairs is generated automatically on a periodic basis and the set of statistics are generated on a demand basis.
Example 7 is the method of Example 1, that may optionally include that the set of statistics include a count or percentage of fraudulent jobs and a count or percentage of legitimate jobs for each of the top attribute-value pairs in the ranked list.
Example 8 is the method of Example 1, that may optionally include that the job processing rule prevents processing of a current job on behalf of the particular subscriber based on a value for the top attribute corresponding to the current job.
Example 9 is the method of Example 1, that may optionally include that each job corresponds to an exchange between a subscriber to the computing platform and a client of the subscriber to the computing platform.
Example 10 is the method of Example 1, that may optionally include that the set of statistics include a monetary value of fraudulent jobs and a monetary value of legitimate jobs for each of the top attribute-value pairs in the ranked list.
Example 10 is a server computer system comprising a memory and a processor coupled to the memory configured to perform the method of any of Examples 1 to 10.
Example 11 is a non-transitory machine-readable medium having executable instructions to cause one or more processing units to perform the computer-implemented method of any of Examples 1 to 10.

It is to be understood that the above description is intended to be illustrative, and not restrictive. Many other embodiments will be apparent to those of skill in the art upon reading and understanding the above description. The scope should, therefore, be determined with reference to the appended claims, along with the full scope of equivalents to which such claims are entitled.

The foregoing description, for purpose of explanation, has been described with reference to specific embodiments. However, the illustrative discussions above are not intended to be exhaustive or to limit the described embodiments to the precise forms disclosed. Many modifications and variations are possible in view of the above teachings. The embodiments were chosen and described in order to best explain the principles and practical applications of the various embodiments, to thereby enable others skilled in the art to best utilize the various embodiments with various modifications as may be suited to the particular use contemplated.

What is claimed is:

1. A method for obtaining insights from detected fraudulent activity in a distributed services system, the method comprising:
determining, by a server computer system of the distributed services system, a set of data related to a set of jobs processed by a computing platform on behalf of subscribers to the computing platform, the set of data including, for each job, a set of attribute-value pairs corresponding to a set of attributes utilized to parameterize each job in the set of jobs;
transforming, by the server computer system, the data into input data for a machine learning (ML) model executed by the server computer system;
generating, with the machine learning (ML) model executed by the server computer system, a ranked list of the set of attribute-value pairs based on predictive utility of each attribute value for identifying jobs involving fraudulent activity;
identifying, by the server computer system, a request to access information associated with the set of jobs for a particular subscriber to the computing platform;
determining, by the server computer system and in response to the request, a set of statistics for a threshold number of top attribute-value pairs in the ranked list;
presenting, by the server computer system, the threshold number of top attribute-value pairs and the set of statistics for the threshold number of top attribute-value pairs via a graphical user interface; and
generating, by the server computer system, a job processing rule for the particular subscriber based on user input identifying a top attribute-value pair in the threshold number of top attribute-value pairs.

2. The method of claim 1, further comprising:
identifying, by the server computer system, an unprocessed job; and
blocking, by the server computer system, processing of the unprocessed job based on the job processing rule.

3. The method of claim 2, wherein blocking processing of the unprocessed job based on the job processing rule is in response to determining that the unprocessed job includes the top attribute-value pair identified based on user input.

4. The method of claim 1, further comprising:
identifying, by the server computer system, an unprocessed job; and
processing, by the server computer system, the unprocessed job based on the job processing rule.

5. The method of claim 1, wherein the ranked list of the set of attribute-value pairs is generated in an offline phase and the set of statistics are generated in an online phase.

6. The method of claim 1, wherein the ranked list of the set of attribute-value pairs is generated automatically on a periodic basis and the set of statistics are generated on a demand basis.

7. The method of claim 1, wherein the set of statistics include a count or percentage of fraudulent jobs and a count or percentage of legitimate jobs for each of the top attribute-value pairs in the ranked list.

8. The method of claim 1, wherein the job processing rule prevents processing of a current job on behalf of the particular subscriber based on a value for the top attribute corresponding to the current job.

9. The method of claim 1, wherein each job corresponds to an exchange between a subscriber to the computing platform and a client of the subscriber to the computing platform.

10. The method of claim 1, wherein the set of statistics include a monetary value of fraudulent jobs and a monetary value of legitimate jobs for each of the top attribute-value pairs in the ranked list.

11. A server computer system, comprising:
a memory; and
a processor coupled to the memory configured to:
determine, by a server computer system of the distributed services system, a set of data related to a set of jobs processed by a computing platform on behalf of subscribers to the computing platform, the set of data including, for each job, a set of attribute-value pairs corresponding to a set of attributes utilized to parameterize each job in the set of jobs;
transform, by the server computer system, the data into input data for a model executed by the server computer system;
generate, with the model executed by the server computer system, a ranked list of the set of attribute-value pairs based on predictive utility of each attribute value for identifying jobs involving fraudulent activity;
identify, by the server computer system, a request to access information associated with the set of jobs for a particular subscriber to the computing platform;
determine, by the server computer system and in response to the request, a set of statistics for a threshold number of top attribute-value pairs in the ranked list;
present, by the server computer system, the threshold number of top attribute-value pairs and the set of statistics for the threshold number of top attribute-value pairs via a graphical user interface; and
generate, by the server computer system, a job processing rule for the particular subscriber based on user input identifying a top attribute-value pair in the threshold number of top attribute-value pairs.

12. The server computer system of claim 11, wherein the processor coupled to the memory is further configured to:
identify an unprocessed job; and
block processing of the unprocessed job based on the job processing rule.

13. The server computer system of claim 12, wherein blocking processing of the unprocessed job based on the job processing rule is in response to determining that the unprocessed job includes the top attribute-value pair identified based on user input.

14. The server computer system of claim 11, wherein the ranked list of the set of attribute-value pairs is generated in an offline phase and the set of statistics are generated in an online phase.

15. The server computer system of claim 11, wherein the ranked list of the set of attribute-value pairs is generated automatically on a periodic basis and the set of statistics are generated on a demand basis.

16. The server computer system of claim 11, wherein the set of statistics include a count or percentage of fraudulent jobs and a count or percentage of legitimate jobs for each of the top attribute-value pairs in the ranked list.

17. A non-transitory computer readable storage medium including instructions that, when executed by a processor, cause the processor to perform operations, the operations comprising:
determining, by a server computer system of the distributed services system, a set of data related to a set of jobs processed by a computing platform on behalf of subscribers to the computing platform, the set of data including, for each job, a set of attribute-value pairs corresponding to a set of attributes utilized to parameterize each job in the set of jobs;
transforming, by the server computer system, the data into input data for a model executed by the server computer system;
generating, with the model executed by the server computer system, a ranked list of the set of attribute-value pairs based on predictive utility of each attribute value for identifying jobs involving fraudulent activity;
identifying, by the server computer system, a request to access information associated with the set of jobs for a particular subscriber to the computing platform;
determining, by the server computer system and in response to the request, a set of statistics for a threshold number of top attribute-value pairs in the ranked list;
presenting, by the server computer system, the threshold number of top attribute-value pairs and the set of statistics for the threshold number of top attribute-value pairs via a graphical user interface; and
generating, by the server computer system, a job processing rule for the particular subscriber based on user input identifying a top attribute-value pair in the threshold number of top attribute-value pairs.

18. The non-transitory computer readable storage medium of claim 17, the operations further comprising:
identifying, by the server computer system, an unprocessed job; and
blocking, by the server computer system, processing of the unprocessed job based on the job processing rule.

19. The non-transitory computer readable storage medium of claim 18, wherein blocking processing of the unprocessed job based on the job processing rule is in response to determining that the unprocessed job includes the top attribute-value pair identified based on user input.

20. The non-transitory computer readable storage medium of claim 17, wherein the set of statistics include a count or percentage of fraudulent jobs and a count or percentage of legitimate jobs for each of the top attribute-value pairs in the ranked list.
